(19) United States
(12) Patent Application Publication
(10) Pub. No.: US 2022/0206506 A1
(43) Pub. Date: Jun. 30, 2022

(54) ROBOT CONTROL SYSTEM, ROBOT CONTROL METHOD, AND PROGRAM

(71) Applicant: TOYOTA JIDOSHA KABUSHIKI KAISHA, Toyota-shi Aichi-ken (JP)

(72) Inventors: Tetsuya TAIRA, Nagakute-shi Aichi-ken (JP); Shiro ODA, Anjo-shi Aichi-ken (JP); Satoshi TOYOSHIMA, Okazaki-shi Aichi-ken (JP); Yuta WATANABE, Toyota-shi Aichi-ken (JP); Takeshi MATSUI, Nisshin-shi Aichi-ken (JP); Takayoshi NASU, Okazaki-shi Aichi-ken (JP); Kei YOSHIKAWA, Nagoya-shi Aichi-ken (JP); Yusuke OTA, Nagakute-shi Aichi-ken (JP); Yutaro ISHIDA, Toyota-shi Aichi-ken (JP); Yuji ONUMA, Nagoya-shi Aichi-ken (JP)

(21) Appl. No.: 17/558,821

(22) Filed: Dec. 22, 2021

(30) Foreign Application Priority Data
Dec. 24, 2020 (JP) 2020-215099

(51) Int. Cl. G05D 1/02; G06V 20/52; G06V 20/58; G06V 40/10

(52) U.S. Cl. CPC G05D 1/0223; G05D 1/0246; G05D 2201/0206; G06V 20/58; G06V 40/10; G06V 20/52

(57) ABSTRACT

A robot control system according to a present embodiment is a robot control system for controlling a mobile robot that is autonomously movable within a facility. The system performs: acquiring attribute information on a person present in a travel area ahead in an advancing direction of the mobile robot; setting an upper limit for operation strength of the mobile robot in accordance with the attribute information; and controlling operation of the mobile robot in accordance with the upper limit.

### CROSS-REFERENCE TO RELATED APPLICATION

This application claims priority to Japanese Patent Application No. 2020-215099 filed on Dec. 24, 2020, incorporated herein by reference in its entirety.

### BACKGROUND

### 1. Technical Field

The present disclosure relates to a robot control system, a robot control method, and a program.

### 2. Description of Related Art

Japanese Unexamined Patent Application Publication No. 9-267276 discloses a delivery robot system that moves in a medical welfare facility.

### SUMMARY

In such a delivery robot system, proper control of a robot is expected.

The present disclosure, which has been made in order to meet such expectation, provides a robot control system, a robot control method, and a program, capable of achieving proper control of the robot.

A robot control system according to a present embodiment is a robot control system for controlling a mobile robot that is autonomously movable within a facility. The system performs: acquiring attribute information on a person present in a travel area ahead in an advancing direction of the mobile robot; setting an upper limit for operation strength of the mobile robot in accordance with the attribute information; and controlling operation of the mobile robot in accordance with the upper limit.

In the control system, the upper limit of the operation strength may be a speed upper limit of moving speed of the mobile robot.

In the control system, the travel area may be imaged by a camera, and the attribute information may be acquired based on the image of the camera.

In the control system, the camera may be an environment camera provided in the facility.

In the control system, the camera may be a robot camera mounted on the mobile robot.

In the control system, the facility may be a medical welfare facility, and the attribute information may include information indicating whether the person is medical personnel or not.

In the control system, the attribute information may include information indicating whether the person is an able-bodied person or a disabled person.

In the control system, the attribute information may include information about age.

A robot control method according to the present embodiment is a robot control method for controlling a mobile robot that is autonomously movable within a facility. The method includes: acquiring attribute information on a person present in a travel area ahead in an advancing direction of the mobile robot; setting an upper limit for operation strength of the mobile robot in accordance with the attribute information; and controlling operation of the mobile robot in accordance with the upper limit.

In the control method, the upper limit of the operation strength may be a speed upper limit of moving speed of the mobile robot.

In the control method, the travel area may be imaged by a camera, and the attribute information may be acquired based on the image of the camera.

In the control method, the camera may be an environment camera provided in the facility.

In the control method, the camera may be a robot camera mounted on the mobile robot.

In the control method, the facility may be a medical welfare facility, and the attribute information may include information indicating whether the person is medical personnel or not.

In the control method, the attribute information may include information indicating whether the person is an able-bodied person or a disabled person.

In the control method, the attribute information may include information about age.

A program according to the present embodiment is a program causing a computer to execute a robot control method for controlling a mobile robot that is autonomously movable within a facility. The robot control method includes: acquiring attribute information on a person present in a travel area ahead in an advancing direction of the mobile robot; setting an upper limit for operation strength of the mobile robot in accordance with the attribute information; and controlling operation of the mobile robot in accordance with the upper limit.

In the program, the upper limit of the operation strength may be a speed upper limit of moving speed of the mobile robot.

In the program, the travel area may be imaged by a camera, and the attribute information may be acquired based on the image of the camera.

In the program, the camera may be an environment camera provided in the facility.

In the program, the camera may be a robot camera mounted on the mobile robot.

In the program, the facility may be a medical welfare facility, and the attribute information may include information indicating whether the person is medical personnel or not.

In the program, the attribute information may include information indicating whether the person is an able-bodied person or a disabled person.

In the program, the attribute information may include information about age.

According to the present disclosure, it is possible to provide a robot control system, a robot control method, and a program, capable of achieving proper control of a mobile robot.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a conceptual diagram for describing an overall configuration of a system that uses a mobile robot according to an embodiment;

FIG. 2 is a control block diagram of a control system according to the present embodiment;

FIG. 3 is a schematic diagram showing an example of a mobile robot;

FIG. 4 is an explanatory view of an example 1;

FIG. 5 is an explanatory view of an example 2;

FIG. 6 is an explanatory view of an example 3; and

FIG. 7 is a flowchart showing a control method according to the present embodiment.

### DETAILED DESCRIPTION OF EMBODIMENTS

While the present disclosure will be described hereinafter through an embodiment of the present disclosure, the present disclosure in the scope as set forth by the claims is not limited by the embodiment disclosed below. Moreover, not all the component members to be described in the embodiment are necessary for accomplishing the object.

Schematic Configuration

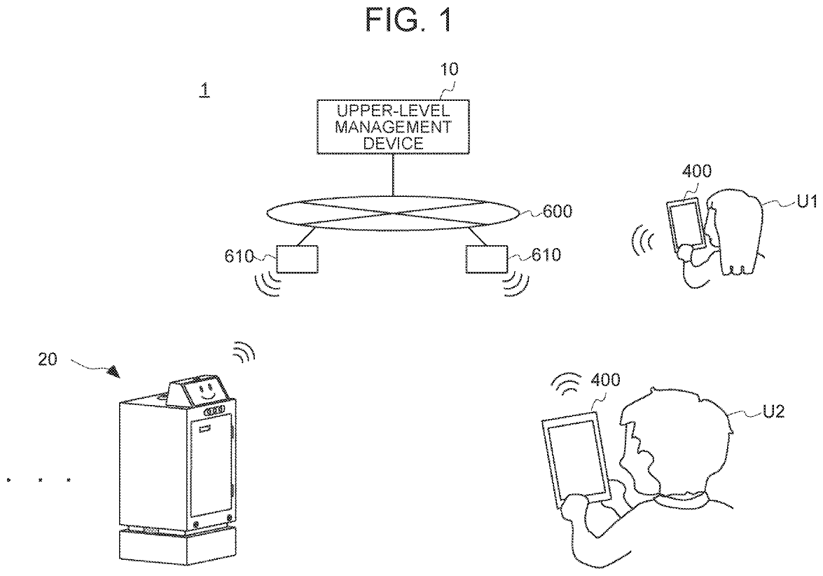

FIG. 1 is a conceptual diagram for describing an overall configuration of a system 1 for using a mobile robot 20 according to an embodiment. For example, the mobile robot 20 is a delivery robot that executes delivery of an article to be delivered as a task. The mobile robot 20 travels autonomously to deliver an article to be delivered within medical welfare facilities, such as hospitals, rehabilitation centers, nursing care facilities, and old-age homes. The system according to the present embodiment can also be used for commercial facilities such as shopping malls.

A user U1 places an article to be delivered in the mobile robot 20 and makes a delivery request. The mobile robot 20 delivers the article to be delivered by moving autonomously to a set target destination. In other words, the mobile robot 20 executes an article delivery task (hereinafter also simply referred to as a task). In the following description, the place to load an article to be delivered is defined as a delivery source, and the place to deliver the article to be delivered is defined as a delivery destination.

For example, it is assumed that the mobile robot 20 moves within a general hospital with a plurality of medical departments. The mobile robot 20 delivers supplies, consumables, medical equipment, and so on between the medical departments. For example, the mobile robot delivers articles to be delivered from the nurse station of one medical department to the nurse station of another medical department. Alternatively, the mobile robot 20 delivers articles to be delivered from a storage room for supplies and medical equipment to the nurse station of any medical department. The mobile robot 20 also delivers drugs dispensed in a pharmacy department to a medical department or patients scheduled to use the drugs.

Examples of the articles to be delivered may include drugs, consumables such as packaging bags, specimens, testing tools, medical equipment, hospital meals, and supplies such as stationery. Examples of the medical equipment may include blood pressure meters, blood transfusion pumps, syringe pumps, foot pumps, nurse callers, bed leaving sensors, low-pressure continuous suction devices, electrocardiogram monitors, drug injection controllers, enteral feeding pumps, artificial respirators, cuff pressure gauges, touch sensors, suction devices, nebulizers, pulse oximeters, blood pressure meters, artificial resuscitators, aseptic devices, and echo devices. The mobile robot 20 may also deliver meals such as hospital meals and foods for examination. The mobile robot 20 may further deliver used equipment, tableware, and the like. This makes it possible to collect used equipment, tableware, and the like. When the delivery destination is on a different floor, the mobile robot 20 may move by using an elevator or other devices.

The system 1 includes one or more mobile robots 20, an upper-level management device 10, a network 600, communication units 610, and user terminals 400. A user U1 or a user U2 can make a delivery request of an article to be delivered by using his or her user terminal 400. For example, the user terminal 400 is a tablet computer or a smartphone. The user terminal 400 may be an information processing device capable of communicating over wireless or wired connections.

In the present embodiment, the mobile robot 20 and the user terminals 400 are connected to the upper-level management device 10 via the network 600. The mobile robot 20 and the user terminal 400 are connected to the network 600 through the communication unit 610. The network 600 is a wired or wireless local area network (LAN) or a wide area network (WAN). The upper-level management device 10 is further connected to the network 600 in a wired or wireless manner. The communication units 610 are, for example, wireless LAN units installed in respective environments. For example, the communication units 610 may be general purpose communication devices, such as WiFi routers.

Various signals output from the user terminals 400 of the user U1 and the user U2 are once sent via the network 600 to the upper-level management device 10, and then transferred from the upper-level management device 10 to a target mobile robot 20. Similarly, various signals output from the mobile robot 20 are once sent via the network 600 to the upper-level management device 10, and then transferred from the upper-level management device 10 to a target user terminal 400. The upper-level management device 10 is a server connected to each device, and collects data from each device. The upper-level management device 10 is not limited to a physically single device. Rather, the upper-level management device 10 may include a plurality of devices that perform distributed processing. The upper-level management device 10 may also be dispersively installed in edge devices such as the mobile robot 20. For example, the system 1 may be partially or entirely mounted on the mobile robot 20.

The user terminal 400 and the mobile robot 20 may exchange signals without via the upper-level management device 10. For example, the user terminal 400 and the mobile robot 20 may exchange signals directly via wireless communication. Alternatively, the user terminal 400 and the mobile robot 20 may exchange signals via the communication unit 610.

The user U1 or the user U2 uses the user terminal 400 to make a delivery request of an article to be delivered. Hereinafter, description will be given on the assumption that the user U1 is a person who makes a delivery request at a delivery source, and the user U2 is an intended recipient at a delivery destination (target destination). Of course, it is possible for the user U2 at the delivery destination to make a delivery request. Users who are at locations other than the delivery source and the delivery destination may also make a delivery request.

When the user U1 makes a delivery request, the user U1 uses the user terminal 400 to input the detail of an article to be delivered, a location that the article to be delivered is picked up (hereinafter also referred to as a delivery source), a delivery location of the article to be delivered (hereinafter also referred to as a delivery destination), estimated time of arrival at the delivery source (time to pick up the article to be delivered), estimated time of arrival at the delivery destination (delivery deadline), and the like. Hereinafter, these pieces of information are also referred to as delivery request information. The user U1 can input delivery request information by operating a touch panel of the user terminal 400. The delivery source may be a place where the user U1 is present, or may be a storage place for the article to be delivered. The delivery destination is the place where the user U2 or a patient who is scheduled to use the article is present.

The user terminal 400 transmits the delivery request information input by the user U1 to the upper-level management device 10. The upper-level management device 10 is a management system that manages a plurality of mobile robots 20. The upper-level management device 10 transmits to the mobile robots 20 an operation command for executing the delivery task. The upper-level management device 10 determines, for each delivery request, the mobile robot 20 used to execute the pertinent delivery task. Then, the upper-level management device 10 transmits to the selected mobile robot 20 a control signal including an operation command. The mobile robot 20 moves from the delivery source to reach the delivery destination according to the operation command.

For example, the upper-level management device 10 assigns a delivery task to the mobile robot 20 at the delivery source or in the vicinity thereof. Alternatively, the upper-level management device 10 assigns a delivery task to the mobile robot 20 approaching the delivery source or the vicinity thereof. The mobile robot 20 assigned with the task goes to the delivery source to pick up an article to be delivered. For example, the delivery source is the place where the user U1 who has requested the task is present.

When the mobile robot 20 arrives at the delivery source, the user U1 or other personnel load the article to be delivered onto the mobile robot 20. The mobile robot 20 loaded with the article to be delivered moves autonomously to the delivery destination as a target destination. The upper-level management device 10 transmits a signal to the user terminal 400 of the user U2 at the delivery destination. This allows the user U2 to know that the article to be delivered is in delivery and to know the scheduled arrival time of the article. When the mobile robot 20 arrives at the set delivery destination, the user U2 can receive the article to be delivered housed in the mobile robot 20. In this way, the mobile robot 20 executes the delivery task.

In this overall configuration, the elements of the control system can be distributed to the mobile robot 20, the user terminal 400, and the upper-level management device 10, and these elements can constitute the control system as a whole. It is also possible to constitute the system by concentrating substantial elements, used for implementing delivery of articles to be delivered, into one device. The upper-level management device 10 controls one or more mobile robots 20.

Control Block Diagram

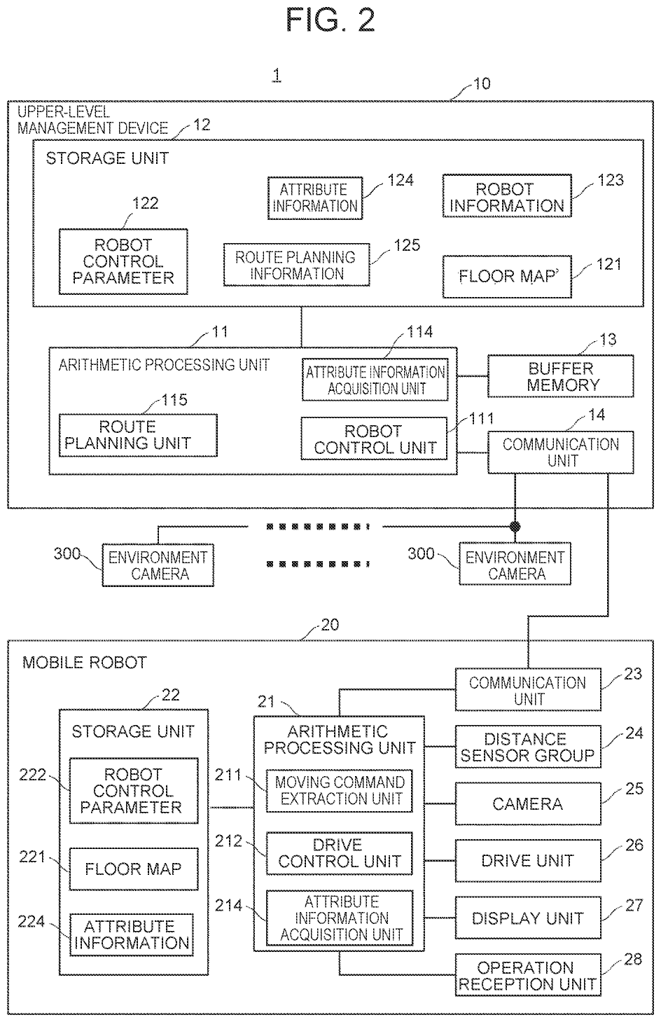

FIG. 2 is a control block diagram showing the control system of the system 1. As shown in FIG. 2, the system 1 includes the upper-level management device 10, the mobile robots 20, and environment cameras 300.

The system 1 efficiently controls the mobile robots 20 while causing the mobile robots 20 to move autonomously within a prescribed facility. For this reason, the environment cameras 300 are installed in the facility. For example, the environment cameras 300 are installed in such places as passages, halls, and elevators in the facility, and facility entrances.

The environment cameras 300 acquire images of a movement range of the mobile robots 20. In the system 1, the images acquired by the environment cameras 300 and the information based on the images are collected by the upper-level management device 10. Alternatively, the images or the like acquired by the environment cameras 300 may be transmitted directly to the mobile robots. The environment cameras 300 may be surveillance cameras provided in the passages inside the facility and the facility entrances. The environment cameras 300 may be used to obtain the distribution of congestion situation inside the facility.

In the system 1 according to a first embodiment, the upper-level management device 10 performs route planning based on delivery request information. Based on the generated route planning information, the upper-level management device 10 specifies a place to go for each of the mobile robots 20. The mobile robots 20 then move autonomously to the places specified by the upper-level management device 10. The mobile robots 20 move autonomously to the specified places (destinations) using sensors installed on themselves, floor maps, position information, or the like.

For example, the mobile robots 20 travel so as to avoid contact with devices, objects, walls, persons therearound (hereinafter collectively referred to as peripheral objects). Specifically, the mobile robots 20 detect a distance to the peripheral objects and travel in the state of being distanced from the peripheral objects by a fixed distance (distance threshold) or more. When the distance to the peripheral objects become equal to or less than the distance threshold, the mobile robots 20 slow down or stop. In this way, the mobile robots 20 can travel without coming into contact with the peripheral objects. Since contact can be avoided, safe and efficient delivery can be achieved.

The upper-level management device 10 includes an arithmetic processing unit 11, a storage unit 12, a buffer memory 13, and a communication unit 14. The arithmetic processing unit 11 performs arithmetic processing to control and manage the mobile robots 20. For example, the arithmetic processing unit 11 can be implemented as a device, such as a central processing unit (CPU) of a computer, which can execute programs. Various functions can also be implemented by the programs. FIG. 2 shows only the characteristic units, including a robot control unit 111, an attribute information acquisition unit 114, and a route planning unit 115, in the arithmetic processing unit 11. However, the arithmetic processing unit 11 can include other processing blocks.

The robot control unit 111 performs arithmetic processing and generates control signals for remotely controlling the mobile robots 20. The robot control unit 111 generates the control signals based on route planning information 125 described later, or the like. The robot control unit 111 further generates the control signals based on various information obtained from the environment cameras 300 and the mobile robots 20. The control signals may include updated information of floor maps 121, robot information 123, and a robot control parameter 122 described later. In other words, when various pieces of information are updated, the robot control unit 111 generates control signals corresponding to the update information.

The attribute information acquisition unit 114 acquires attribute information based on the images acquired by the environment cameras 300 and cameras 25 of the mobile robots 20. The attribute information will be described later. The robot control unit 111 may generate control signals based on the attribute information. The communication unit 14 transmits the control signals generated by the robot control unit 111 to each of the mobile robots 20.

The route planning unit 115 performs route planning for each of the mobile robots 20. When a delivery task is input, the route planning unit 115 performs route planning for delivering a pertinent article to be delivered to a delivery destination (target destination) based on the delivery request information. Specifically, the route planning unit 115 refers to the route planning information 125 already stored in the storage unit 12, the robot information 123, and so on to determine the mobile robot 20 that is to execute a new delivery task. A place of departure is a place such as a current position of the mobile robot 20, the delivery destination of an immediately prior delivery task of the mobile robot 20, and a location where the article to be delivered is picked up. A target destination is a place such as a delivery destination of the article to be delivered, a waiting place, and a charging place.

Here, the route planning unit 115 sets passing points between the place of departure to the target destination of the mobile robot 20. The route planning unit 115 sets a passing order of the passing points for each of the mobile robots 20. For example, the passing points are set to junctions, intersections, lobbies in front of the elevators, and the peripheries thereof. In narrow passages, it may be difficult for the mobile robots 20 to pass each other. In such cases, points in front of the narrow passages may be set as the passing points. Passing point candidates may be registered on the floor map 121 in advance.

The route planning unit 115 determines, out of the mobile robots 20, the mobile robot 20 used to execute each of the delivery tasks such that the system as a whole can efficiently execute the tasks. The route planning unit 115 preferentially assigns the delivery tasks to the mobile robots 20 in a waiting state or to the mobile robots 20 located close to the delivery sources.

The route planning unit 115 sets, for the mobile robots 20 assigned with the delivery tasks, the passing points including the place of departure and the target destination. For example, when there are two or more moving routes from the delivery source to the delivery destination, the route planning unit 115 sets the passing points such that the mobile robots 20 can move in a shorter time. For this reason, the upper-level management device 10 updates information indicating the congestion situation of the passages based on the camera images and the like. Specifically, the places where other mobile robots 20 are passing through, and where there are many people are high in congestion degree. Therefore, the route planning unit 115 sets the passing points so as to avoid the places with a high congestion degree.

There are cases where the mobile robots 20 can move to the target destinations in both a counterclockwise moving route and a clockwise moving route. In such cases, the route planning unit 115 sets the passing points so as to pass along the less-congested moving route. Since the route planning unit 115 sets one or more passing points to the target destination, the mobile robots 20 can move along non-congested moving routes. For example, when a passage is branched at a junction or an intersection, the route planning unit 115 sets passing points at the junction, the intersection, corners, and the peripheries thereof as appropriate. This makes it possible to enhance the delivery efficiency.

The route planning unit 115 may set the passing points based on the congestion situation of elevators, moving distances, and the like. The upper-level management device 10 may further estimate the number of the mobile robots 20 and the number of persons at the time when a given mobile robot 20 is scheduled to pass through a given place. Depending on the estimated congestion situation, the route planning unit 115 may set the passing points. The route planning unit 115 may also change the passing points dynamically in accordance with changes of the congestion situation. For the mobile robots 20 assigned with delivery tasks, the route planning unit 115 sets the passing points in order. The passing points may include the delivery source and the delivery destination. As will be described later, the mobile robots 20 move autonomously so as to pass the passing points, set by the route planning unit 115, in order.

The storage unit 12 is a storage unit to store information necessary for management and control of the robots. In the example shown in FIG. 2, the floor map 121, the robot information 123, the robot control parameter 122, the attribute information 124, the route planning information 125 are shown. However, the storage unit 12 may store other information. The arithmetic processing unit 11 performs arithmetic operation using the information stored in the storage unit 12 at the time of performing various processes. The various information stored in the storage unit 12 can be updated as appropriate.

The floor map 121 is map information on the facility where the mobile robots 20 are made to move. This floor map 121 may be generated in advance, generated based on the information obtained from the mobile robots 20, or may be generated by adding map correction information, prepared based on the information obtained from the mobile robots 20, to a basic map generated in advance.

The robot information 123 describes information such as IDs, model numbers, and specifications of the mobile robots 20 managed by the upper-level management device 10. The robot information 123 may include position information indicating the current positions of the mobile robots 20. The robot information 123 may include information indicating whether the mobile robots 20 are executing tasks or in the waiting state. The robot information 123 may include information indicating whether the mobile robots 20 are in operation, out of order, or the like. The robot information 123 may also include information about deliverable and non-deliverable articles to be delivered.

The robot control parameter 122 describes control parameters such as threshold distances of the mobile robots 20 managed by the upper-level management device 10 to the peripheral objects. The threshold distances are margin distances to avoid contact with peripheral objects, including persons. The robot control parameter 122 may further include information about operation strength, such as speed upper limit for the moving speed of the mobile robots 20.

The robot control parameter 122 may be updated based on the attribute information as will be described later. The robot control parameter 122 may include information indicating a vacancy status and a use status of housing space of a housing cabinet 291. The robot control parameter 122 may also include information about deliverable and non-deliverable articles to be delivered. The robot control parameter 122 is associated with the various information for each of the mobile robots 20.

The attribute information 124 is the attribute information acquired by the attribute information acquisition unit 114. Here, the attribute information 124 about the persons in the facility is stored in association with the position information on the persons.

The route planning information 125 includes information on route plans planned in the route planning unit 115. For example, the route planning information 125 includes information indicating delivery tasks. The route planning information 125 may include the IDs of the mobile robots 20 assigned with tasks, the places of departure, the details of the articles to be delivered, delivery destinations, estimated time of arrival at the delivery destinations, estimated time of arrival at the delivery sources, and delivery deadlines. The route planning information 125 may be associated with the various information for each of the delivery tasks. The route planning information 125 may include at least some of the delivery request information input by the user U1.

The route planning information 125 may further include information about the passing points for each of the mobile robots 20 or for each of the delivery tasks. For example, the route planning information 125 includes information indicating a passing order of the passing points for each of the mobile robots 20. The route planning information 125 may include coordinates of each passing point on the floor map 121 and information indicating whether the mobile robots 20 have passed the passing points.

The route planning unit 115 refers to the various information stored in the storage unit 12 to formulate a route plan. For example, the route planning unit 115 determines the mobile robot 20 that is to execute a task, based on the floor map 121, the robot information 123, the robot control parameter 122, and the route planning information 125. The route planning unit 115 then sets the passing points to the delivery destination and a passing order thereof with reference to the floor map 121. In the floor map 121, passing point candidates are registered in advance. The route planning unit 115 sets the passing points in accordance with the congestion situation or the like. In the case of continuous processing of tasks, the route planning unit 115 may set the delivery source and the delivery destination as the passing points.

It is also possible to assign a single delivery task to two or more mobile robots 20. For example, when an article to be delivered is larger than the deliverable capacity of the mobile robot 20, the article to be delivered is divided into two parts, and is loaded onto two mobile robots 20. Alternatively, when an article to be delivered is heavier than the deliverable weight of the mobile robot 20, the article to be delivered is divided into two parts, and is loaded onto two mobile robots 20. In this way, two or more mobile robots 20 can share and execute one delivery task. Of course, in the case of controlling mobile robots 20 of different sizes, route planning may be conducted to make the mobile robots 20, capable of delivering articles to be delivered, pick up the articles.

Further, one mobile robot 20 may perform two or more delivery tasks in parallel. For example, two or more articles to be delivered may simultaneously be loaded onto one mobile robot 20, and delivered to different delivery destinations in sequence. Alternatively, while one mobile robot 20 delivers one article to be delivered, another article to be delivered may be loaded onto the mobile robot 20. Moreover, the articles to be delivered, which are loaded at different places, may have the same delivery destination, or may have different delivery destinations. In this way, tasks can efficiently be executed.

In such cases, housing information indicating the use status or the vacancy status of the housing space in the mobile robot 20 may be updated. In other words, the upper-level management device 10 can control the mobile robots 20 by managing the housing information indicating the vacancy status. For example, when loading or pickup of an article to be delivered is completed, the housing information is updated. When a delivery task is input, the upper-level management device 10 refers to the housing information, and dispatches the mobile robot 20, having enough space for loading an article to be delivered, to pick up the article. In this way, one mobile robot 20 can execute a plurality of delivery tasks at the same time, and two or more mobile robots 20 can share and execute one delivery task. For example, a sensor may be installed in the housing space of the mobile robots 20 to detect the vacancy status. In addition, the volume and weight of each article to be delivered may be registered in advance.

The buffer memory 13 is a memory that accumulates intermediate information generated in processing performed in the arithmetic processing unit 11. The communication unit 14 is a communication interface for communicating with the environment cameras 300 and at least one mobile robot 20 installed in the facility that uses the system 1. The communication unit 14 can perform both the wired communication and wireless communication. For example, the communication unit 14 transmits to each of the mobile robots 20 control signals required to control each of the mobile robots 20. The communication unit 14 also receives information collected by the mobile robots 20 and the environment cameras 300.

The mobile robot 20 includes an arithmetic processing unit 21, a storage unit 22, a communication unit 23, and proximity sensors (for example, a distance sensor group 24), cameras 25, a drive unit 26, a display unit 27, and an operation reception unit 28. FIG. 2 shows only the typical processing blocks included in the mobile robot 20. However, the mobile robot 20 includes many other processing blocks which are not illustrated.

The communication unit 23 is a communication interface for communicating with the communication unit 14 of the upper-level management device 10. The communication unit 23, for example, uses radio signals to communicate with the communication unit 14. For example, the distance sensor group 24 is proximity sensors that output proximity object distance information indicating the distance to an object or a person present around the mobile robot 20. The cameras 25 photograph, for example, images in order to grasp the situation around the mobile robot 20. The cameras 25 can also photograph location markers provided, for example, on the ceiling of the facility. The location markers may be used to cause the mobile robot 20 to know its own position.

The drive unit 26 drives drive wheels provided on the mobile robot 20. The drive unit 26 may also have encoders to detect the number of rotation of the drive wheels and their drive motors. The own position (current position) of the mobile robot 20 may be estimated in accordance with the output of the encoders. The mobile robot 20 detects the own current position, and transmits the own current position to the upper-level management device 10.

The display unit 27 and the operation reception unit 28 are implemented with a touch panel display. The display unit 27 displays a user interface screen serving as the operation reception unit 28. The display unit 27 may display the destination of the mobile robot 20 and information indicating the state of the mobile robot 20. The operation reception unit 28 receives an operation from a user. The operation reception unit 28 includes the user interface screen displayed on the display unit 27, as well as various switches provided on the mobile robot 20.

The arithmetic processing unit 21 performs arithmetic operation for use in control of the mobile robot 20. For example, the arithmetic processing unit 21 can be implemented as a device, such as a central processing unit (CPU) of a computer that can execute programs. Various functions can also be implemented by the programs. The arithmetic processing unit 21 includes a moving command extraction unit 211, a drive control unit 212 and an attribute information acquisition unit 214. FIG. 2 shows only the typical processing blocks included in the arithmetic processing unit 21. However, the arithmetic processing unit 21 may include processing blocks which are not illustrated. The arithmetic processing unit 21 may also search for a route between passing points.

The moving command extraction unit 211 extracts a moving command from a control signal given from the upper-level management device 10. For example, the moving command includes information about a next passing point. For example, the control signal may include coordinates of the passing points and information about a passing order of the passing points. The moving command extraction unit 211 extracts these information pieces as the moving command.

The moving command may further include information indicating that moving to the next passing point is enabled. When a passage width is narrow, the mobile robots 20 may not be able to pass each other in the passage. Moreover, there may be cases where some passages are temporarily closed. In such cases, the control signal includes a command to stop the mobile robot 20 at a passing point before the place to stop. Then, after another mobile robot 20 has passed or the passage has become passable, the upper-level management device 10 outputs a control signal indicating that moving is enabled to the mobile robot 20. This causes the mobile robot 20 in a temporary stopped state to restart moving.

The drive control unit 212 controls the drive unit 26 to move the mobile robot 20 based on the moving command given from the moving command extraction unit 211. For example, the drive unit 26 has drive wheels that rotate in accordance with a control command value from the drive control unit 212. The moving command extraction unit 211 extracts the moving command so as to move the mobile robot 20 toward the passing point received from the upper-level management device 10. The drive unit 26 then rotationally drives the drive wheels. The mobile robot 20 moves autonomously toward the next passing point. In this way, the mobile robot 20 passes through the passing points in turn and arrives at the delivery destination. The mobile robot 20 may estimate its own position, and transmit a signal indicating that the mobile robot 20 has passed the passing point to the upper-level management device 10. Thus, the upper-level management device 10 can manage the current position and the delivery status of each of the mobile robots 20.

Like the attribute information acquisition unit 114, the attribute information acquisition unit 214 acquires information on the attribute of persons. The attribute information acquisition unit 214 acquires information on the attribute of persons present around the mobile robot 20 based on the images acquired by the cameras 25 of the mobile robot 20. In the following description, the attribute information acquisition unit 114 in the upper-level management device 10 mainly performs the process of acquiring the attribute information by itself. However, the attribute information acquisition unit 214 in the mobile robot 20 may perform the process of acquiring the attribute information. Alternatively, the attribute information acquisition unit 114 and the attribute information acquisition unit 214 may perform the process of acquiring the attribute information by cooperating with each other or by dividing their respective roles. Moreover, at least one of the attribute information acquisition unit 114 and the attribute information acquisition unit 214 may be omitted.

The storage unit 22 stores the floor map 221 and the robot control parameter 222. FIG. 2 shows some of the information stored in the storage unit 22. The storage unit 22 may also store information other than the floor map 221 and the robot control parameter 222 shown in FIG. 2. The floor map 221 is map information on the facility where the mobile robot 20 is made to move. The floor map 221 is, for example, the floor map 121 downloaded from the upper-level management device 10. The floor map 221 may be prepared in advance. The floor map 221 may also be map information partially including areas that the mobile robot 20 is scheduled to travel, instead of the map information on the entire facility.

The robot control parameter 222 is a parameter used to operate the mobile robot 20. The robot control parameter 222 includes, for example, a threshold of distance to the peripheral objects. The robot control parameter 222 may further function as a setting unit that sets an upper limit of the operation strength of the mobile robot. Specifically, the robot control parameter 222 includes speed upper limit of the mobile robot 20. Alternatively, when the mobile robot 20 has a robot arm, the operation strength may be operation speed of the robot arm.

The drive control unit 212 refers to the robot control parameter 222, and stops or decelerates its operation in response to that the distance information obtained from the distance sensor group 24 becomes lower than the distance threshold. The drive control unit 212 controls the drive unit 26 so as to travel at speeds equal to or less than the speed upper limit. The drive control unit 212 limits the rotation speed of the drive wheels such that the mobile robot 20 does not move at speeds above the speed upper limit.

Like the attribute information 124, the attribute information 224 is acquired by the attribute information acquisition unit 214 or the attribute information acquisition unit 114. The attribute information 224 is the information on the attribute of persons present in a travel area ahead in the advancing direction of the mobile robot 20. Therefore, the attribute information 224 may be only the attribute information on some persons who are in the vicinity of the mobile robot 20, among the attribute information 124.

Configuration of Mobile Robot 20

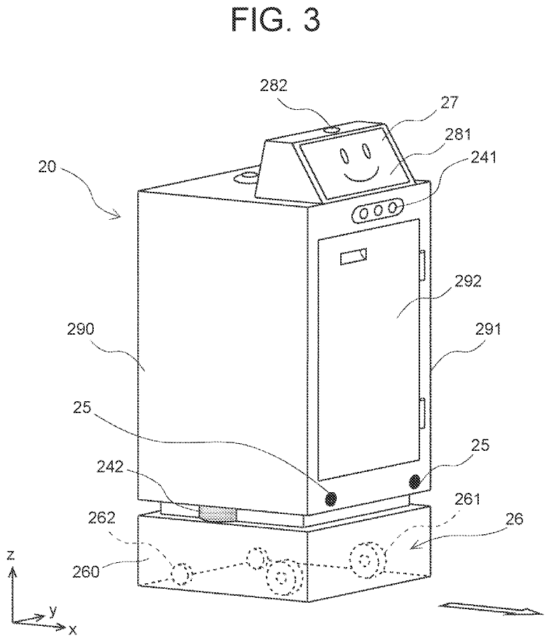

Here, the appearance of the mobile robot 20 will be described. FIG. 3 shows a schematic diagram of the mobile robot 20. The mobile robot 20 shown in FIG. 3 is one aspect of the mobile robot 20. The mobile robot 20 may have any other configuration. In FIG. 3, an x-direction is a forward direction and backward direction of the mobile robot 20, a y-direction is a right and left direction of the mobile robot 20, and a z-direction is the height direction of the mobile robot 20.

The mobile robot 20 includes a body unit 290 and a truck unit 260. The body unit 290 is mounted on top of the truck unit 260. The body unit 290 and the truck unit 260 each have a rectangular parallelepiped casing, in which each component member is mounted. For example, the drive unit 26 is housed in the truck unit 260.

The body unit 290 includes the housing cabinet 291 serving as housing space and a door 292 that seals the housing cabinet 291. The housing cabinet 291 has a plurality of stages of racks, and the vacancy status is managed for each stage. For example, the vacancy status can be updated by disposing various sensors such as weight sensors in each stage. The mobile robot 20 moves autonomously to deliver an article to be delivered that is housed in the housing cabinet 291 to the target destination specified by the upper-level management device 10. The body unit 290 may incorporate a control box or the like, which is not illustrated, in the casing. The door 292 may be lockable with an electronic key or the like. Upon arrival at the delivery destination, the user U2 unlocks the door 292 with the electronic key. Alternatively, at the time of arrival at the delivery destination, the door 292 may be opened automatically.

As shown in FIG. 3, front-rear distance sensors 241 and right-left distance sensors 242 are provided, as the distance sensor group 24, on the exterior of the mobile robot 20. The mobile robot 20 measures the distance to the peripheral objects in the front-rear direction of the mobile robot 20 with the front-rear distance sensors 241. The mobile robot 20 also measures the distance to the peripheral objects in the right-left direction of the mobile robot 20 with the right-left distance sensors 242.

For example, the front-rear distance sensors 241 are disposed on a front surface and a rear surface of the casing of the body unit 290. The right-left distance sensors 242 are disposed on a left-side surface and a right-side surface of the casing of the body unit 290. For example, the front-rear distance sensors 241 and the right-left distance sensors 242 are ultrasonic distance sensors or laser range finders. The front-rear distance sensors 241 and the right-left distance sensors 242 detect the distance to the peripheral objects. When the distance to the peripheral objects detected by the front-rear distance sensors 241 or the right-left distance sensors 242 becomes the distance threshold or less, the mobile robot 20 slows down or stops.

The drive unit 26 is equipped with drive wheels 261 and casters 262. The drive wheels 261 are wheels to move the mobile robot 20 forward, backward, rightward and leftward. The casters 262 are following wheels to which no driving force is applied. The casters 262 rotate by following the drive wheels 261. The drive unit 26 has a drive motor, which is not illustrated, to drive the drive wheels 261.

For example, the drive unit 26 supports, in the casing, two drive wheels 261 and two casters 262, each of which is grounded to a travel surface. The two drive wheels 261 have rotation shafts provided so as to coincide with each other. The drive wheels 261 are each independently driven by an unillustrated motor. The drive wheels 261 rotate in response to control command values from the drive control unit 212 in FIG. 2. The casters 262 are following wheels provided such that pivot shafts, extending perpendicularly from the drive unit 26, pivotably support the wheels with a distance from the rotation shafts of the wheels. The casters 262 follow so as to trace the moving direction of the drive unit 26.

For example, the mobile robot 20 moves forward when the two drive wheels 261 rotate in the same direction at the same rotation speed, whereas when the drive wheels 261 rotate in the opposite directions at the same rotation speed, the mobile robot 20 pivots around a perpendicular axis passing through substantially the center of the two drive wheels 261. When the two drive wheels 261 rotate in the same direction at different rotation speeds, the mobile robot 20 can move while turning right and left. For example, the mobile robot 20 can turn right by setting the rotation speed of the left drive wheel 261 higher than the rotation speed of the right drive wheel 261. Conversely, the mobile robot 20 can turn left by setting the rotation speed of the right drive wheel 261 higher than the rotation speed of the left drive wheel 261. This means that the mobile robot 20 can translate, pivot, turn right and left, and so on, in any direction by controlling the rotation direction and the rotation speed of the two drive wheels 261.

The mobile robot 20 also has a display unit 27 and an operation interface 281 on the upper surface the body unit 290. The display unit 27 displays an operation interface 281. When a user touches and operates the operation interface 281 displayed on the display unit 27, the operation reception unit 28 can receive user instructions. An emergency stop button 282 is also provided on the upper surface of the display unit 27. The emergency stop button 282 and the operation interface 281 function as the operation reception unit 28

The display unit 27 is a liquid crystal panel, for example. The display unit 27 displays a character's face as an illustration, and displays information about the mobile robot 20 by text or icons. When the character's face is displayed on the display unit 27, it can give viewers around the mobile robot 20 an impression that the display unit 27 is a pseudo face. It is also possible to use the display unit 27, or the like, mounted on the mobile robot 20 as the user terminal 400.

The cameras 25 are installed on the front surface of the body unit 290. In this example, two cameras 25 function as a stereo camera. In other words, two cameras 25 with the same viewing angle are disposed horizontally apart from each other. Images taken by the cameras 25 are output as image data. Based on the image data from the two cameras 25, it is possible to calculate the distance to a subject and the size of the subject. By analyzing the image of the cameras 25, the arithmetic processing unit 21 can detect persons and obstacles ahead in the moving direction. If there are persons or obstacles ahead in the advancing direction, the mobile robot 20 moves along the route while avoiding them. The image data from the cameras 25 is transmitted to the upper-level management device 10.

The mobile robot 20 analyzes the image data output from the cameras 25 and detection signals output from the front-rear distance sensors 241 and the right-left distance sensors 242, and thereby recognizes peripheral objects or identifies the own position. The cameras 25 image a forward area in the advancing direction of the mobile robot 20. The forward area of the mobile robot 20 is at the side of the mobile robot 20 where the cameras 25 are installed as shown in the drawing. In other words, during normal movement, the forward direction of the mobile robot 20 is the advancing direction as indicated with an arrow.

Attribute Information

Description is now given of the attribute information 124 acquired by the attribute information acquisition unit 114 in FIG. 2. The attribute information is information indicating the attributes of persons present in the facility. The facility is used by a large number of unspecified people, such as facility personnel, facility users, and visitors. The facility personnel include doctors, nurses, caregivers, pharmacists, engineers, and physiotherapists. There are also facility personnel other than medical personnel, such as IT department staff. The users include inpatients, and outpatients. In addition, visitors of the inpatients, and attendants of the outpatients also use the facility. The visitors include suppliers of equipment, supplies, and drugs.

In medical welfare facilities such as hospitals, there are many users who are disabled persons such as those with disabilities. Many users walk using, for example, wheelchairs, crutches, walkers, handrails, walking carts, and canes. Some users walk with a drip stand. These persons with difficulty in walking walk slower than able-bodied persons. Elderly persons and children may also have slow walking speeds. Therefore, when the mobile robot 20 approach a person with difficulty in walking, it may not be possible for the person with difficulty in walking to quickly avoid the mobile robot 20.

Accordingly, in the present embodiment, the attribute information acquisition unit 114 acquires the attribute information on the persons who are present around each of the mobile robots 20. The robot control unit 111 can vary the speed upper limits of the mobile robots 20 in accordance with the attribute information. For example, when a person with difficulty in walking, who walks using crutches, is near the mobile robot 20, the speed upper limit of the mobile robot 20 is lowered. In this way, the person with difficulty in walking can walk near the mobile robot 20 without worry.

Specifically, the environment cameras 300 and the cameras 25 of the robot image the travel area ahead in the moving direction of the mobile robot 20. Then, the attribute information acquisition unit 114 acquires the attribute information on a person or persons present in the travel area based on the image data from the cameras 25 and the environment cameras 300. For example, the attribute information acquisition unit 114 uses image analysis to detect a person in an image. The attribute information acquisition unit 114 then determines whether the person present in the image is using any equipment. The attribute information acquisition unit 114 identifies a walking aid, such as walkers, crutches, and canes, by image analysis. The attribute information acquisition unit 114 also identifies wheelchairs, drip stands, and the like. The attribute information acquisition unit 114 can acquire each of the attribute information. The attribute information acquisition unit 114 may further determine the speed upper limit depending on the equipment in use.

The attribute information may include information indicating whether the person is medical personnel or not. When the attribute information acquisition unit 114 detects a person, the attribute information acquisition unit 114 estimates whether the person is medical personnel or not. Alternatively, when medical personnel are made to carry a non-contact IC chip for short-distance radio communication, it may be possible to omit detection of objects which causes high processing loads.

For example, medical personnel usually wear uniforms, which makes it possible to easily determine them by image analysis. Since there are high possibilities that medical personnel are employees such as doctors, nurses, caregivers, pharmacists, and physiotherapists, it is highly likely that they can walk at normal walking speeds. Medical personnel working in the facility are familiar with the operation of the mobile robots 20. When the detected person is medical personnel, the robot control unit 111 maintains a high-speed upper limit. Alternatively, when a name tag worn by employees who are medical personnel is detected, the attribute information acquisition unit 114 determines that the person having the name tag as medical personnel. When medical equipment such as stethoscopes typically held by medical personnel is detected, the attribute information acquisition unit 114 determines that the person holding the medical equipment as medical professional. In these cases, the robot control unit 111 also maintains the high-speed upper limit.

When the detected person is a general user other than the medical personnel, the robot control unit 111 lowers the speed upper limit. Since the general users other than medical personnel do not have knowledge about the operation of the mobile robots 20, they may suddenly approach the mobile robots 20. Therefore, for the mobile robots 20 that move close to the general users, the robot control unit 111 sets a lower speed upper limit. This makes it possible to execute tasks safely and efficiently.

The attribute information includes information about age. For example, when the detected person is a general user, the speed upper limit may be variable according to the age of the user. The attribute information acquisition unit 114 estimates the age of the general users. The attribute information acquisition unit 114 may further lower the speed limit depending on the age of the general users. According to age, the attribute information acquisition unit 114 may determine infants, children, minors, elderly, adults, etc. For example, when there is an elderly person or an infant, the speed upper limit may further be lowered. This means that persons are classified according to age, and the speed upper limit is further lowered only where there is an elderly person or an infant.

The attribute information may include information indicating an able-bodied person or a disabled person. When a person present in the travel area uses canes, crutches, walkers, plaster casts, drip stands, wheelchairs, or the like, the speed upper limit is further lowered. When a person using a walking aid or wheelchair is detected by image analysis, the attribute information acquisition unit 114 determines the person as the person with difficulty in walking. In this case, the robot control unit 111 lowers the speed upper limit to the lowest. When a specific device or person is detected, the speed upper limit of the mobile robot 20 may be set to zero. In other words, when the specific device or person is detected, the mobile robot 20 may be stopped temporarily.

In this way, the robot control unit 111 sets the speed upper limit in accordance with the attribute information on a person or persons present in the travel area. Then, the upper-level management device 10 transmits the speed upper limit to the mobile robot 20. The transmitted speed upper limit is stored in the robot control parameter 222. The mobile robot 20 travels at the speeds equal to or less than the speed upper limit. For example, the drive control unit 212 controls the rotation speed of the drive wheels 261 such that the mobile robot 20 moves at the speeds equal to or less than the speed upper limit in the vicinity of the person with difficulty in walking. In this way, it is possible to enhance safety more and to perform efficient task processing. It becomes possible to perform efficient control suitable for the situation in the medical welfare facility.

The robot control unit 111 sets the speed upper limit in stages in accordance with the attribute information. When only the medical personnel are present, a high-speed mode is used. In the high-speed mode, for example, the speed upper limit is 3 km. When there is any person with difficulty in walking who uses canes, crutches, plaster casts, drip stands, or wheelchairs, a low-speed mode is used. When there is any infant or elderly person, the low-speed mode is used. In the low-speed mode, the speed is around 0.5 km/H, for example. When there is a general user or users, but there is no person with difficulty in walking, no elderly person, and no infant, a medium speed mode is used. In the medium speed mode, the speed is around 1 km/H. Of course, the present embodiment is not limited to the speed set in stages or the speed upper limit.

The upper speed limit may also be variable for each area in the facility. The facility may be divided into a plurality of areas in advance, and the speed upper limit may be set for each area. For example, the floor maps 121, 221 may include information about the upper speed limit. The speed upper limit may be high in a staff only area where only the medical personnel are permitted, and the speed upper limit may be low in areas where there are general users other than the medical personnel. Specifically, the speed upper limit is set lower in areas where general users can enter, such as around the entrance of the facility and the reception area. The areas where the medical personnel can enter by presenting the ID, or the like, may be set as the staff only area.

The speed upper limits included in the floor maps 121 and 221 may be updated at any time by collecting images of the environment cameras 300 and the cameras 25 of the mobile robots 20. For example, when a person with difficulty in walking, an elderly person, and a child are detected at a detection point, the speed upper limit at the detection point and the vicinity thereof may be lowered on the floor map. When the person with difficulty in walking, the elderly person, and the child have moved out of the detection point, the speed upper limit on the floor map may be returned to an original value. The upper-level management device 10 transmits the floor map including the information on the speed upper limits to the mobile robots 20. The upper-level management device 10 transmits some part of the floor map in the vicinity of each of the mobile robots 20. The mobile robots 20 may read the upper speed limit from the floor map 221.

At least some of the processing of the attribute information acquisition unit 114 may be performed by the environment cameras 300 or the mobile robots 20. For example, the processors mounted on the environment cameras 300 or the mobile robots 20 may perform image analysis to determine the attribute of persons. Then, the upper-level management device 10 may receive the attribute information from the environment cameras 300 or the mobile robots 20.

### Example 1

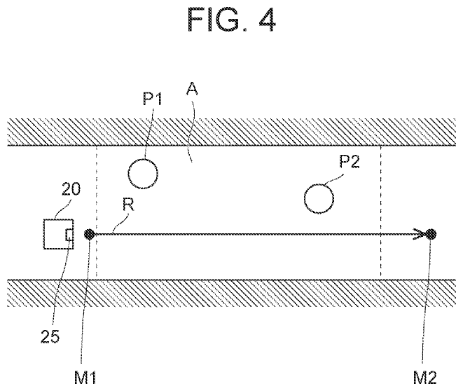

FIG. 4 is an explanatory view of an example 1 for acquiring the attribute information. In FIG. 4, the attribute information is obtained based on the images of the cameras 25 mounted on the mobile robot 20. Assume that the mobile robot 20 is moving along a route R from a passing point M1 to a passing point M2. In a travel area A ahead in the moving direction, there are a person P1 and a person P2. The travel area A is an area that is ahead of the mobile robot 20 and that extends over a prescribed distance from the mobile robot 20.

The cameras 25 image the travel area A ahead in the moving direction. Therefore, the person P1 and the person P2 are in the images of the cameras 25. The upper-level management device 10 receives image data of the cameras 25. The attribute information acquisition unit 114 acquires the attribute information on the person P1 and the person P2 by analyzing the images of the cameras 25. For example, when the person P2 is using a walking aid, the lowest speed upper limit is set. When both the person P1 and the person P2 present in the travel area A are medical personnel, the highest speed upper limit is set.

In the example 1, the mobile robot 20 can set the upper speed limit by itself. In this case, the attribute information acquisition unit 214 in the mobile robot 20 acquires the attribute information. The cameras 25 take an image ahead in the moving direction of the mobile robot 20. The arithmetic processing unit 21 may analyze the image of the cameras 25, and thereby the attribute information acquisition unit 214 may acquire the attribute information on the persons present in the travel area.

### Example 2

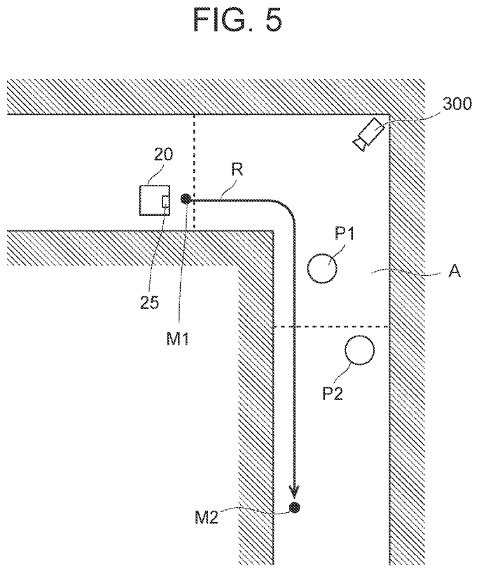

FIG. 5 is an explanatory view of an example 2 for acquiring the attribute information. In the example 2, assume that the mobile robot 20 is moving along a route R from a passing point M1 to a passing point M2. More specifically, the mobile robot 20 turns right along the route R.

Therefore, based on the images of the environment camera 300 installed in the facility, the attribute information acquisition unit 114 acquires the attribute information on the person P1 and the person P2. For example, at intersections or corners, blind spots of the cameras 25 are created in the travel area A ahead in the moving direction. Therefore, in the example 2, the attribute information acquisition unit 114 acquires the attribute information based on the image of the environment camera 300 installed at the corner. In this way, the speed upper limit can be set before the mobile robot 20 reaches the corner.

For example, the upper-level management device 10 receives image data of the environment camera 300. The attribute information acquisition unit 114 analyzes the image of the environment camera 300, and thereby acquires the attribute information on the person P1 in the travel area A. For example, when the person P1 is using a walking aid, the low-speed mode is used. When the person P1 in the image of the environment camera 300 is medical personnel, the high-speed mode is used. Of course, in the example 2, the attribute information may be determined using images from the cameras 25 of the mobile robot 20.

The attribute information may be generated through image processing performed on the image data from the environment camera 300 by the attribute information acquisition unit 214 of the mobile robot 20. In this case, the image data of the environment camera is transmitted to the mobile robot 20.

### Example 3

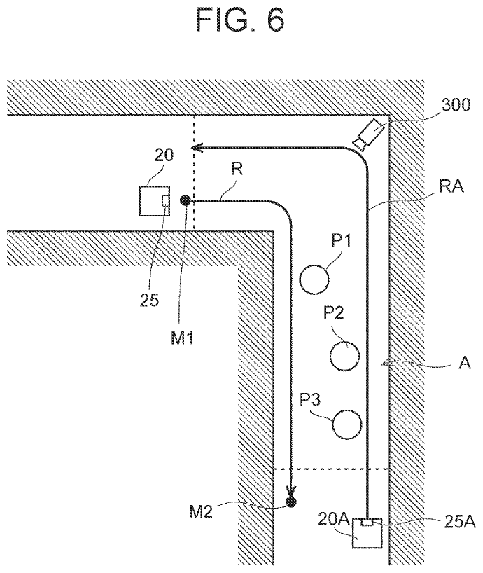

FIG. 6 is an explanatory view of an example 3 for acquiring the attribute information. In the example 3, in addition to the configuration shown in FIG. 5, a mobile robot 20A turns left at the corner along a route RA from the opposite direction. In the travel area A, there is also a person P3. In the example 3, based on the images from the environment camera 300, from the cameras 25 of the mobile robot 20, and from cameras 25A of the mobile robot 20A, the attribute information acquisition unit 114 acquires the attribute information on each of the persons P1 to P3. In other words, based on images of the travel area A taken from a plurality of directions, the attribute information acquisition unit 114 acquires the attribute information.

In FIG. 6, the persons P1 to P3 are present in the travel area A. There is the person P2 between the environment camera 300 and the person P3. Therefore, there are possibilities that the environment camera 300 can only partially image the person P3. When the person P3 is only partially imaged, it is difficult to determine the attribute through image analysis. Accordingly, in the present embodiment, the attribute information acquisition unit 114 acquires the attribute information based on the images of the cameras 25A of the mobile robot 20A.

In this way, it is possible to accurately determine the attributes of all the persons P1 to P3 present in the travel area A. In other words, when there is no mobile robot 20A that moves in the travel area A from the opposite direction, it is not possible to image the person P3. By using a plurality of cameras with different imaging directions in this way, it is possible to enhance the accuracy of determining the attributes through image analysis processing.

Note that the attribute information may be acquired from the images taken with the cameras 25A of the mobile robot 20A. The mobile robot 20A may transmit the attribute information directly to the mobile robot 20 together with the position information on the person P3. Of course, the mobile robot 20A may transmit the attribute information to the upper-level management device 10. Then, the upper-level management device 10 that manages the current position of the mobile robot 20 may transmit the attribute information on the person P3 to the mobile robot 20.

When the persons P1, P2 are medical personnel, and the person P3 is a person with difficulty in walking, the robot control unit 111 sets the speed upper limit to the lowest. By using a plurality of cameras in this way, it is possible to reduce the blind spots. This makes it possible to enhance the accuracy of determining the attribute information on persons. Therefore, the mobile robots 20 can execute delivery tasks more safely and efficiently.

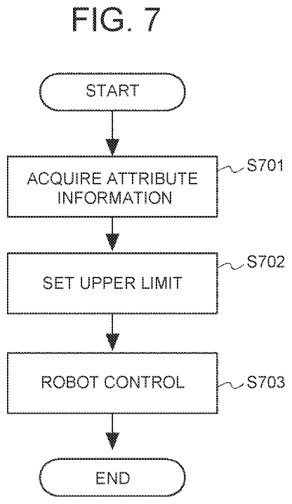

FIG. 7 is a flowchart showing a control method according to the present embodiment. FIG. 7 shows processing to be performed subsequent to route planning that is performed in response to a delivery request. In other words, FIG. 7 shows the process by the upper-level management device 10 while the mobile robot 20 is moving.

First, the attribute information acquisition unit 114 acquires attribute information (S701). For example, the environment cameras 300 and the cameras 25 image the travel area ahead in the advancing direction. The upper-level management device 10 receives images from the environment camera 300 and the cameras 25. The upper-level management device 10 acquires the attribute information on persons present in the travel area based on the images.

Next, the arithmetic processing unit 11 sets an upper limit for the operation of the mobile robot 20 based on the attribute information (S702). For example, when a general user other than the medical personnel is present in the travel area, the arithmetic processing unit 11 lowers the speed upper limit. When the general user is a person with difficulty in walking, the arithmetic processing unit 11 further lowers the speed upper limit.

Based on the upper limit set in this way, the robot control unit 111 performs robot control (S703). In other words, when the speed upper limit is updated, the upper-level management device 10 transmits the speed upper limit to the mobile robot 20. The mobile robot 20 travels at the speeds equal to or less than the speed upper limit.

In this way, appropriate control of the mobile robots can be achieved. For example, when a person with difficulty in walking, an elderly person, or an infant is in the travel area, the mobile robot 20 moves in the low-speed mode. When only medical personnel are present in the travel area, the mobile robot 20 moves in the high-speed mode. As a result, tasks can be processed safely and efficiently.

Moreover, some or all of the processing in the upper-level management device 10 or the mobile robots 20 can be implemented as computer programs. Such programs can be stored and supplied to computers using various types of non-transitory computer readable media. The non-transitory computer readable media include various types of tangible storage media. Examples of the non-transitory computer readable media includes magnetic recording media (e.g. flexible disks, magnetic tapes, hard disk drives), magneto-optical recording media (e.g. magneto-optical disks), read only memories (CD-ROMs), CD-Rs, CD-RWs, semiconductor memories (e.g. mask ROMs, programmable ROMs (PROMs), erasable PROMs (EPROMs), flash ROMs, and random access memories (RAMs)). The programs may be supplied to computers using various types of transitory computer-readable media. Examples of the transitory computer-readable media include electrical signals, optical signals, and electromagnetic waves. The transitory computer-readable media can supply the programs to computers via wired communication channels, such as wires, and optical fibers, or wireless communication channels.

Note that the present disclosure is not limited to the embodiment disclosed, and appropriate modifications may be made without departing from the scope of the present disclosure. For example, in the embodiment disclosed, the system including delivery robots that move autonomously inside a hospital has been described. However, the system allows a prescribed item to be delivered as an article in hotels, restaurants, office buildings, event venues, or composite facilities.

What is claimed is:

1. A robot control system for controlling a mobile robot that is autonomously movable within a facility, the robot control system performing:
acquiring attribute information on a person present in a travel area ahead in an advancing direction of the mobile robot;
setting an upper limit for operation strength of the mobile robot in accordance with the attribute information; and
controlling operation of the mobile robot in accordance with the upper limit.

2. The robot control system according to claim 1, wherein the upper limit of the operation strength is a speed upper limit of moving speed of the mobile robot.

3. The robot control system according to claim 1, wherein:
the travel area is imaged by a camera; and
the attribute information is acquired based on the image of the camera.

4. The robot control system according to claim 3, wherein the camera is an environment camera provided in the facility.

5. The robot control system according to claim 3, wherein the camera is a robot camera mounted on the mobile robot.

6. The robot control system according to claim 1, wherein:
the facility is a medical welfare facility; and
the attribute information includes information indicating whether the person is medical personnel or not.

7. The robot control system according to claim 1, wherein the attribute information includes information indicating whether the person is an able-bodied person or a disabled person.

8. The robot control system according to claim 1, wherein the attribute information includes information about age.

9. A robot control method for controlling a mobile robot that is autonomously movable within a facility, the method comprising:
acquiring attribute information on a person present in a travel area ahead in an advancing direction of the mobile robot;
setting an upper limit for operation strength of the mobile robot in accordance with the attribute information; and
controlling operation of the mobile robot in accordance with the upper limit.

10. The robot control method according to claim 9, wherein the upper limit of the operation strength is a speed upper limit of moving speed of the mobile robot.

11. The robot control method according to claim 9, wherein the travel area is imaged by a camera; and the attribute information is acquired based on the image of the camera.

12. The robot control method according to claim 11, wherein the camera is an environment camera provided in the facility.

13. The robot control method according to claim 11, wherein the camera is a robot camera mounted on the mobile robot that is autonomously movable.

14. The robot control method according to claim 9, wherein:
the facility is a medical welfare facility; and
the attribute information includes information indicating whether the person is medical personnel or not.

15. The robot control method according to claim 9, wherein the attribute information includes information indicating whether the person is an able-bodied person or a disabled person.

16. The robot control method according to claim 9, wherein the attribute information includes information about age.

17. A program causing a computer to execute a robot control method for controlling a mobile robot that is autonomously movable within a facility, the robot control method including:
acquiring attribute information on a person present in a travel area ahead in an advancing direction of the mobile robot;
setting an upper limit for operation strength of the mobile robot in accordance with the attribute information; and
controlling operation of the mobile robot in accordance with the upper limit.

18. The program according to claim 17, wherein the upper limit of the operation strength is an upper limit of moving speed of the mobile robot.

19. The program according to claim 17, wherein:
the travel area is imaged by a camera; and
the attribute information is acquired based on the image of the camera.

20. The program according to claim 19, wherein the camera is an environment camera provided in the facility.

21. The program according to claim 19, wherein the camera is a robot camera mounted on the robot that is autonomously movable.

22. The program according to claim 19, wherein:
the facility is a medical welfare facility; and
the attribute information includes information indicating whether the person is medical personnel or not.

23. The program according to claim 19, wherein the attribute information includes information indicating whether the person is an able-bodied person or a disabled person.

24. The program according to claim 19, wherein the attribute information includes information about age.
